(19) United States
(12) Patent Application Publication
(10) Pub. No.: US 2026/0105439 A1
(43) Pub. Date: Apr. 16, 2026

(54) DECENTRALIZED E-CASH PAYMENTS THROUGH NON-FUNGIBLE TOKENS

(71) Applicant: Bank of America Corporation, Charlotte, NC (US)

(72) Inventors: Subburathinam Krishnan, Chennai (IN); Amit Mishra, Chennai (IN); Krithika Viswanathan, Chennai (IN); Anurajam Rajagopalan, Chennai (IN); Kambhampati Sri Lalitha Devi, Chennai (IN)

(21) Appl. No.: 18/914,409

(22) Filed: Oct. 14, 2024

(51) Int. Cl. G06Q 20/36; G06Q 20/06; G06Q 20/38; G06Q 20/40

(52) U.S. Cl. CPC G06Q 20/363; G06Q 20/065; G06Q 20/381; G06Q 20/4014

(57) ABSTRACT

Apparatus and methods for utilizing non-fungible tokens (“NFTs”) for decentralized e-cash payments are provided. A payor and a payee may each have a wallet on a distributed ledger. A payor and payee may use a computer program product to connect over a computer network with each other. The computer program product may mint an NFT on the distributed ledger when prompted to start a payment from the payor to the payee. The NFT may include metadata, one or more payment terms, and one or more smart contracts. The one or more smart contracts may include bespoke code created by the computer program product for each transaction. The NFT may be transferred from the payor to the payee. The payee may select an option to obtain the e-cash. The e-cash may be transferred to the payee per the selection.

### FIELD OF TECHNOLOGY

Aspects of the disclosure relate to providing apparatus and methods for decentralized e-cash payments utilizing non-fungible tokens (“NFTs”).

### BACKGROUND OF THE DISCLOSURE

Current cash-based payment technology may be limited to actual cash and various e-cash payment applications where funds are directly transferred electronically from one bank account to another.

These e-cash payment applications may have various security risks, such as: payment platform snooping where malicious actors obtain secured private information such as user credentials for payment and other applications used during the transactions; transactional data interpolation where data transmitted during a payment transaction may be intercepted by a malicious actor and amended (e.g., amount of recipient); direct application interference when payments are directly linked with a financial institution account, allowing for various attack vectors by a malicious actor ; and payment uncertainty as the payment may not be accomplished via secured channel(s) causing lack of trust by users.

Regardless of the ease of current e-cash applications, the issues above (and other issues) may lead to malicious activity. Therefore, an e-cash payment method that solves one or more of the security issues is desirable.

Non-fungible tokens (“NFTs”) are unique digital tokens tradeable and used on a blockchain or other distributed ledger. The nature of NFTs may solve one or more of the security issues identified above. If a distributed ledger or blockchain is utilized for the digital transaction, counterparty risk may be eliminated as the information is permanently available and immutable/unchangeable. Further, the payment activity may be permanently stored and accessible at any time while it is stored on the distributed ledger or blockchain. This may allow the payee to retain the payment information from a statement long after money has been utilized.

Currently, there is no apparatus or method available to provide decentralized and real-time e-cash payments through non-fungible tokens on a distributed ledger.

Therefore, it would be desirable for apparatus and methods to provide decentralized and real-time e-cash payments through non-fungible tokens on a distributed ledger.

### SUMMARY OF THE DISCLOSURE

It is an object of this disclosure to provide apparatus and methods for decentralized real-time e-cash payments utilizing non-fungible tokens (“NFTs”).

An e-cash payment computer program product is provided. The computer program product may include executable instructions that may be executed by a processor (or processors) on a computer system. The executable instructions may be stored in non-transitory memory n the computer system or a remote computer system, such as a server.

The e-cash payment computer program product may assign to each of two or more users, a separate wallet on a distributed ledger.

Each user may include a computer device running the computer program product. At least one of the two or more users may be a payee and at least one of the two or more users may be a payor.

The program may establish, over a computer network, a connection between each computer device.

The program may receive, via the connection and from one of the two or more users, one or more payment terms. The one or more payment terms may include an identity of the payor, an identity of the payee, an amount of the payment, e-cash, and one or more options to convey the e-cash selectable by the payee.

E-cash may refer to and include a digital representation of a portion of funds available to the payor that is the equivalent of physical cash and may be used similarly to cash for payment purposes.

The program may initiate a payment from the payor according to the one or more payment terms.

The program may mint a non-fungible token (“NFT”) comprising metadata and one or more smart contracts on the distributed ledger and within the wallet assigned to the payor. The NFT may be singular.

The one or more smart contracts may include code created by a request intent extractor, an intelligent feature processor, and a multi-module real-time intelligent feature bundler.

The request intent extractor may be configured to determine an intent for the one or more smart contracts.

The intelligent feature processor may be configured to determine which one or more features located within a central feature catalog corresponds with the intent and are compatible with the distributed ledger.

The intelligent feature processor may be configured to transmit the determined one or more features to the multi-module real-time intelligent feature bundler.

The multi-module real-time intelligent feature bundler may be configured to receive the one or more determined features, extract source code corresponding to the one or more determined features from a store of source code, and bundle the extracted source code to create the one or more smart contracts.

The program may transmit, via the connection, an option to the payee to accept or reject a transfer of the NFT to the payee's wallet.

When the payee accepts the transfer of the NFT, the program may transfer, via the connection and after receiving an authorization from the payor, the NFT to the wallet assigned to the payee.

The program may confirm receipt of the NFT at the payee distributed ledger wallet.

The program may convey the e-cash as instructed by the payee.

In an embodiment, the NFT or one or more of the one or more payment terms may be encrypted.

In an embodiment, the payee distributed ledger wallet and the payor distributed ledger wallet are located on one distributed ledger.

In an embodiment, the distributed ledger may be a blockchain.

In an embodiment, the one or more payment terms may be accessed through a hyperlink. The hyperlink may appear on a screen of the computer device. The hyperlink may be displayed by the computer program.

In an embodiment, the NFT may be machine-readable.

In an embodiment, the program may transmit a report to the payor when any the following occurs: 1) the NFT is viewed; 2) the payment is conveyed; and 3) any combination of the above.

In an embodiment, one or more of: the request intent extractor; the intelligent feature processor; and the multi-module real-time intelligent feature bundler may utilize one or more artificial intelligence/machine learning (“AI/ML”) algorithms.

In an embodiment, the one or more AI/ML algorithms may analyze, at least, the one or more payment terms, historical data of the payor, historical data of the payee, and metadata.

In an embodiment, the NET may expire after a pre-determined amount of time.

In an embodiment, the pre-determined amount of time may be set by the payor.

In an embodiment, the pre-determined amount of time may be determined automatically one or more AI/ML algorithms.

In an embodiment, when the NET expires, all e-cash unused by the payee may be returned to the payor.

In an embodiment, the usage of any e-cash by the payee may be tracked by the program.

In an embodiment, the computer network may be wi-fi based.

In an embodiment, the computer network may be li-fi based.

In an embodiment, one of the one or more options to convey the e-cash selectable by the payee may include an option to convert from one currency to another currency.

In an embodiment, the e-cash may be automatically converted from one currency to another currency.

In an embodiment, when the payee fails to select one of the one or more options within a predetermined amount of time, the NFT may be automatically returned to the wallet assigned to the payor.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic in accordance with principles of the disclosure.

FIG. 4 shows an illustrative schematic in accordance with principles of the disclosure.

FIG. 5 shows an illustrative flowchart in accordance with principles of the disclosure.

FIG. 6 shows an illustrative apparatus in accordance with principles of the disclosure.

FIG. 7 shows an illustrative schematic in accordance with principles of the disclosure.

FIG. 8 shows an illustrative schematic in accordance with principles of the disclosure.

### DETAILED DESCRIPTION OF THE DISCLOSURE

It is an object of this disclosure to provide apparatus and methods for utilizing distributed ledgers and non-fungible tokens (“NFTs”) for e-cash payment.

Distributed ledger technology may refer to a decentralized, tamperproof, and transactional database. A distributed ledger may provide a distributed, immutable, transparent, secure, and auditable ledger of transactions. The distributed ledger may provide a secure way to store and process transactions among trusted and untrusted nodes on a network.

The distributed ledger may be a public or un-permissioned distributed ledger. A public distributed ledger may not have restrictions on who may participate in establishing a consensus for adding a new record. For example, records stored in a public distributed ledger may only be added to the ledger when systems that rely on the distributed ledger reach a consensus. The distributed ledger may use any suitable consensus algorithm such as Proof of Work, Proof of Stake or Practical Byzantine Fault Tolerance.

The distributed ledger may be a private or permissioned distributed ledger. A private distributed ledger may include restrictions on who may participate in establishing a consensus for adding a new record.

The distributed ledger may utilize a combination of private and public participation to establish a consensus. For example, the distributed ledger may require a threshold number of private and/or public agreements before recording a transaction on the distributed ledger. Utilization of private entities may allow for achieving a consensus (or rejection) of a transaction faster than wholly public distributed ledgers.

The program may record one or more payment terms associated with a payment in a distributed ledger. Illustrative payment terms may include a type of currency (e.g., USD, EUR, AUD, GBP, JPY, CAD), an amount of currency, the payor's digital wallet and the payee's digital wallet, and a deadline for using the payment.

The distributed ledger may include a protocol that allows transactions to be verified by unreliable nodes. The distributed ledger can be consulted openly and fully, allowing access to all transactions that have occurred since the first transaction of the system, and can be verified and collated by any entity at any time. The distributed ledger also stores transactional information in a fashion that prevents alteration of the records stored in the distributed ledger. Therefore, if the ledger states that a particular token belongs to a particular wallet, and the movement of the token can be traced from the moment it first appeared in the ledger, that data may be trusted and may be used for various purposes.

The distributed ledger may store information in linked segments, or a chain of “blocks.” The linked blocks may collectively form a “blockchain.” Each block may store a set of transactions performed at a given time. Blocks are linked or chained to each other by a reference to the previous block. Each block in the distributed ledger is linked to the previously approved block using a cryptographic hash code of the previous block.

Distributed ledger security may be accomplished by imposing strict rules and mutual agreement among nodes when attempting to add a new block of transactions to the distributed ledger. The strict rules and mutual agreement protocols may be referred to as a consensus mechanism. The consensus mechanism synchronizes the decentralized ledger across all nodes that write to the distributed ledger. The consensus mechanism ensures that all nodes agree on a single authoritative copy of the distributed ledger. Nodes that write to the distributed ledger network may be programmed to recognize the longest chain in a network of nodes as the authoritative source of information for the distributed ledger.

A key component of the consensus mechanism may be proof of work. In one embodiment of a distributed ledger, each node must successfully solve a computationally intensive task before adding a new block to the distributed ledger. The proof of work must be complex to solve and at the same time easily verifiable once completed. This dichotomy ensures that only one node is authorized to add a new block and that all other nodes can easily verify that the new block has been properly linked to a prior block. The computationally intensive nature of the block generation process provides tamperproof and auditable transactional database. Alternatively, a more recent paradigm is proof of stake in lieu of proof of work. Proof of stake may be less energy intensive and faster computationally. Other, known and unknown, methods of ensuring a distributed ledger's validity may be used as well as proof of work or proof of stake.

It may be computationally expensive for a malicious attacker to modify a block and attempt to corrupt its contents. The rest of the trusted nodes on the network would continuously generate new blocks, outrunning the attacker in the block generation process. Therefore, a trusted branch of blocks will grow faster than any blocks that can be generated by the attacker. Nodes on a network are programmed to recognize the longest chain in the network as the authoritative source of information. The nodes on the network will therefore invalidate any shorter chains generated by the attacker.

In order for a manipulated block to be successfully added to the distributed ledger, it would be necessary for the malicious attacker to solve the proof of work faster than the rest of nodes on the network. This is structured to be computationally too expensive for the attacker. Accomplishing this feat requires having control of at least 51% of the computing resources in the network.

A transaction or block may be referred to as a token. A token may also be a representation of data included within a transaction or block. Generally, a token is a unit of data stored on distributed ledger. The token may include unique data. The data may be hashed, creating a unique hash. A token may also represent data or information outside of a transaction or block, as in, for example, various cryptocurrencies. Tokens may be fungible. Tokens may be non-fungible. Fungible tokens, such as cryptocurrencies, are interchangeable. Non-fungible tokens (“NFTs”) may be unique and singular (or in limited quantities) and are non-interchangeable. Distributed ledger technology may be used to provide and verify public proof of ownership of tokens. While all units (copies, or tokens) of a particular cryptocurrency may be mutually interchangeable (and thus fungible), non-fungible tokens are not mutually interchangeable. Currently, distributed ledgers may be used to verify ownership of tokens.

NFTs may commonly be used to tokenize specific digital data, such as artwork, legacy code, or some other digital data. However, nothing limits NETS to tokenizing artwork or other typical data.

Distributed ledgers may use security methods such as public-key cryptography. A public key may be a long, random-looking string of numbers or other intensive data. The public key may function as a computerized address on the ledger, belonging to a particular user. The address may include a computerized wallet that may contain data or information belonging to the user, along with assets belonging to the user. Units of data, such as tokens, sent across the ledger may be recorded as belonging to that address. Along with the public key, a user may have a private key, which may be linked to the public key. A private key may function as a password that gives the user access to her address and wallet and allow the user to interact with the distributed ledger.

Distributed ledgers may be centralized or decentralized. In a centralized ledger, a server, or group of servers, may maintain the authoritative copy of the ledger, and any node interacting with the ledger (to view or update) may have to be approved by the server or servers. However, in a decentralized system, every node may have a copy of the ledger and no centralized or official copy of the ledger may exist.

Distributed ledgers/blockchains may be public or private (i.e., conclave or permissioned). Private ledgers may use an access control layer to determine who has access to the ledger to view or add to the ledger.

Distributed ledger smart contracts may be code or programs on the ledger that may be partially or fully started, executed, or enforced without human interaction. Smart contracts may be standalone programs. Smart contracts may be programs or applications that require a specific distributed ledger to run. Smart contracts may be transferable. Smart contracts may be (and in many instances, should be) customized for a particular user and/or purpose. Smart contracts may include user interface(s). Smart contracts may include customizable user interface(s). Smart contracts may be customized to run efficiently on one or more computing devices. In an embodiment, a smart contract may act as the main interface for a user in this disclosure. Smart contract(s) may be referred to as a program or application.

As long as the parties to a smart contract understand what the smart contract will and will not do, actions taken by the smart contract may be binding on the parties. NFTs may include one or more smart contracts.

E-cash may refer to and may include a digital representation of a portion of funds available to the payor that is the equivalent of physical cash and may be used similarly to cash for payment purposes.

An e-cash payment computer program product is provided. The computer program product may include executable instructions that may be executed by a processor (or processors) on a computer system. Multiple processors may increase the speed and capability of the program. The executable instructions may be stored in non-transitory memory on the computer system or a remote computer system, such as a server. Other standard components of the computer system may be present.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The computer system may be a server. The computer system may be run on smart mobile device. The computer program, or portions of the computer program may be linked to other computers or servers running the computer program. The server or servers may be centralized or distributed.

The e-cash payment computer program product may assign to each of two or more users, a separate and distinct wallet on a distributed ledger, so that each user has its own wallet. In an embodiment, a user may set up its own wallet, instead of the server assigning a wallet.

Each user may include a computer device running the computer program product. At least one of the two or more users may be a payee and at least one of the two or more users may be a payor.

The program may establish, over a computer network, a connection between each computer device. The network may be the internet or other public network. The network may be an intranet or other private network.

The program may receive, via the connection and from one of the two or more users, one or more payment terms. The one or more payment terms may include an identity of the payor, an identity of the payee, an amount of the payment, e-cash, and one or more options to convey the e-cash selectable by the payee. Other payment terms may also be included. The payment terms may also include metadata. The one or more payment terms may be encrypted. Any suitable encryption method may be used.

The program may initiate a payment from the payor according to the one or more payment terms. For example, if the payor wants to pay $100 to a payee, those payment terms may be provided to the program and the program may initiate the transaction.

To transfer the payment, the program may mint (i.e., create) a non-fungible token (“NFT”) comprising metadata and one or more smart contracts on the distributed ledger and within the wallet assigned to the payor. The metadata may include some or all of the one or more payment terms. The one or more smart contracts may include a program to complete the transaction. The smart contract may include a user interface customized for the distributed ledger and the device belonging to the payee. The NFT may be singular.

The one or more smart contracts may include code created by a request intent extractor, an intelligent feature processor, and a multi-module real-time intelligent feature bundler.

The request intent extractor may be configured to determine an intent for the one or more smart contracts. In general, the intent will be to transfer the e-cash to the payee through the NFT and the distributed ledger, according to the one or more payment terms. There may be multiple ways to code a program to do so. One feature may be to tailor the code to the device belonging to the payee/recipient. Another feature may be to tailor the payee's options on selecting how the e-cash should be transferred.

The intelligent feature processor may be configured to determine which one or more features located within a central feature catalog corresponds with the intent and are compatible with the distributed ledger and/or the computer device belonging to the payee.

The intelligent feature processor may be configured to transmit the determined one or more features to the multi-module real-time intelligent feature bundler.

The multi-module real-time intelligent feature bundler may be configured to receive the one or more determined features, extract source code corresponding to the one or more determined features from a store of source code, and bundle the extracted source code to create the one or more smart contracts.

The program may transmit, via the connection, an option to the payee to accept or reject a transfer of the NFT to the payee's wallet.

When the payee accepts the transfer of the NFT, the program may transfer, via the connection and after receiving an authorization from the payor, the NFT to the wallet assigned to the payee.

The program may confirm receipt of the NFT at the payee distributed ledger wallet. Once the NFT is received, the one or more smart contracts within the NFT may be activated by the payee. The one or more smart contracts may include one or more options for the payee to select on how to convey the e-cash to a bank account belonging to the payee, or otherwise use the e-cash.

The program may convey the e-cash as instructed by the payee.

In an embodiment, the NFT or one or more of the one or more payment terms may be encrypted. Any suitable encryption method may be used.

In an embodiment, the payee distributed ledger wallet, and the payor distributed ledger wallet are located on one distributed ledger. When both wallets are located on the same ledger, it may be easier and consume less resources for minting the NFT and transferring the NFT.

In an embodiment, the payee distributed ledger wallet, and the payor distributed ledger wallet may be located on different distributed ledgers. When both wallets are located on different ledgers, the smart contract may be tailored to work specifically on the ledger where the payee's wallet is located.

In an embodiment, the distributed ledger may be a blockchain. Blockchains may be among the more secure versions of distributed ledgers.

In an embodiment, the one or more payment terms may be accessed through a hyperlink. The hyperlink may appear on a screen of the computer device. The hyperlink may be displayed by the computer program.

In an embodiment, the one or more smart contracts may be accessed through a hyperlink. The hyperlink may appear on a screen of the computer device. The hyperlink may be displayed by the computer program.

In an embodiment, the NFT may be machine-readable. This may include machine code, a QR code, a barcode, or other machine-readable displays.

In an embodiment, the program may transmit a report to the payor when any the following occurs: 1) the NFT is viewed; 2) the payment is conveyed; and 3) when the payee spends all or a portion of the e-cash.

In an embodiment, one or more of: the request intent extractor; the intelligent feature processor; and the multi-module real-time intelligent feature bundler may utilize one or more artificial intelligence/machine learning (“AI/ML”) algorithms. Any suitable AI/ML algorithm may be used.

In an embodiment, the one or more AI/ML algorithms may analyze, at least, the one or more payment terms, historical data of the payor, historical data of the payee, device data, distributed ledger characteristics and history, and metadata.

In an embodiment, the NFT may expire after a pre-determined amount of time. For example, the NFT may expire one hour after minting, providing the intended recipient a short amount of time to retrieve the e-cash, but also preventing a malicious actor from acting.

In an embodiment, the pre-determined amount of time may be set by the payor.

In an embodiment, the pre-determined amount of time may be determined automatically through one or more AI/ML algorithms. Longer times may afford a malicious actor more time to act. Shorter times may prevent the payee from accessing the funds.

In an embodiment, when the NET expires, all e-cash unused by the payee may be returned to the payor. This may prevent a malicious actor from using the funds if left by the payee or forgotten by the payee.

In an embodiment, the usage of any e-cash by the payee may be tracked by the program. Tracking may allow the program to determine how the payee is using the e-cash. For example, if a parent wants to provide e-cash to a child, but does not want the child to spend the e-cash on certain items or services, the program may track the usage and alert the parent.

In an embodiment, the program may limit the use of the e-cash according to parameters and limits set by the payee or payor.

In an embodiment, the computer network may be wi-fi based. In an embodiment, the computer network may be li-fi based. Other computer network protocols may be used.

In an embodiment, one of the one or more options to convey the e-cash selectable by the payee may include an option to convert from one currency to another currency. Converting from one currency to another may allow for seamless cross-border transactions.

In an embodiment, the e-cash may be automatically converted from one currency to another currency. The program may know that the payor and payee are in different countries that use different currencies and automatically convert the e-cash when necessary.

In an embodiment, when the payee fails to select one of the one or more options within a predetermined amount of time, the NFT may be automatically returned to the wallet assigned to the payor.

Transmissions may be through any suitable apparatus or method, such as a smart phone, a personal computer, a server, smart glasses, or other devices. The transmission may be over the Internet, through a cellular connection, bluetooth, wi-fi, a local area network, li-fi or any other suitable communication protocol. Li-fi may refer to “light fidelity” networks, where data is transmitted through visible or invisible light pulses instead of radio waves as in traditional communication protocols.

The one or more payment terms may include, inter alia, an identity of the payor, an identity of the payee, an amount of the payment, a location of one or more assets comprising the payment, one or more options to convey the e-cash selectable by the payee, wallet addresses, distributed ledger data, a duration of payment, an expiration of payment, as well as other terms. These terms may be encrypted.

NFTs may take any appropriate form, including a hyperlink, a pdf, one or more smart contracts, or other digital data, or a combination of the above. The NFT may be editable. In an embodiment, the program may display the NFT to the payor before transmission so that the payor may confirm all contents.

The NFT may include, inter alia, metadata and one or more smart contracts. The metadata may include, inter alia, any standard data necessary for the NFT to function as an NFT on a distributed ledger. Different distributed ledgers may require different data. The smart contract may be code (i.e., a program or application) configured to function as described in this disclosure. The smart contract may be customized to run on the computer device belonging to the payee. The smart contract may include features configured to transfer e-cash from the payor to the payee. The smart contract may include one or more options for the payee to choose how to receive the funds.

The NFT may be singular. Some NFTs may have multiple (but limited) copies or may be broken into a finite number of parts (e.g., a wallet may have 1/10^{th} of an NFT). However, singular NFTs should have zero copies and may not be divided into parts.

The initial location of the NET may be within a payor distributed ledger wallet belonging to the payor. A distributed ledger wallet may be a unique address on the ledger that may be accessed by, or belong, to a single person or entity. The payor wallet may be an address on a distributed ledger belonging to the payor. The payor's wallet may be on a single distributed ledger. In an embodiment, the payor's wallet may have access to multiple distributed ledgers (i.e., the wallet may include multiple addresses).

In an embodiment, the NFT may include a graphical user interface (“GUI”). In an embodiment, the smart contract may include a GUI. In an embodiment, the computer program may include a GUI. The GUI may include a display of the one or more options to convey the e-cash. The one or more options may be selectable. The one or more options may be listed vertically, with a box or button to the side of each option that a viewer may select.

In an embodiment, the smart contract/GUI may include an ability to request a password, PIN, one-time password, or other authenticator from the payee before transferring the payment funds as selected. The authenticator may be a biometric authenticator (such as facial recognition, fingerprint, retinal scan, or other biometric authenticator).

In an embodiment, the funds may be e-cash, an electronic equivalent to physical cash. In an embodiment, the funds for the payment may be a cryptocurrency (e.g., a fungible token) or a combination of cryptocurrencies or other digital assets available (other NFTs) on the distributed ledger. In an embodiment, the funds may be a bespoke method of accessing the funds from a standard bank or bank account.

The NFT may include one or more smart contracts as well as the payment itself, allowing the payee to access the payment within one transaction, as well as creating an immutable record of the statement on the distributed ledger for historical and other purposes. The one or more smart contracts may be code or programs used to implement aspects of the invention.

The program may request approval from the payor for the contents of the NFT after creation of the NFT. The payor may request changes be made by the program or approve the NFT. The payor may transmit an authorization to the program to release/transmit the NET. Any suitable communication method may be used. Any suitable authenticator may be used.

After receiving an authorization to transmit the NFT (and/or release the payment) from the payor, the program may transfer the NFT to a payee distributed ledger wallet belonging to a payee. Any suitable or appropriate transmission protocol or method may be used by the program. Different distributed ledgers may have various requirements as to the transfer of an NFT from one address to another address (i.e., from one wallet to another wallet). There may be a transmission cost, payable in cryptocurrency or otherwise, associated with each transfer or transaction.

The program may confirm receipt of the NFT at the payee distributed ledger wallet. As distributed ledgers may be immutable, the transfer of a token, fungible or non-fungible, from one address to another address may be permanently recorded on the ledger. The program may confirm receipt of the NFT by the payee's wallet by querying the ledger.

Through the one or more smart contracts, the program may then convey the e-cash as instructed by the payee. The NFT may include various options as to how the payee could receive the payment/funds that are included in the NFT. For example, the payee may have the option of transferring the funds into the payee's wallet, another wallet, a bank account or otherwise. In an embodiment, the payee may be able to use the funds within the NFT as collateral for a loan or other financial vehicle. In an embodiment, the payee may be able to use the funds within the NFT to pay off other debts or obligations.

In an embodiment, one or more payment terms or other data, including metadata, within the NFT may be encrypted. In an embodiment, part of or all of the NFT may be encrypted. Any suitable encryption method may be used.

As tokens and other data on a distributed ledger may be viewable by anyone with access to the ledger (although not modified), encryption may be preferable. A decryption key may be provided separately or within the computer program.

In an embodiment, the payee distributed ledger wallet, and the payor distributed ledger wallet may be located on the same distributed ledger. This ledger may be provided by a financial institution or may exist outside of a financial institution. For example, if the payee and payor are customers of the same financial institution, the institution may provide a distributed ledger for its customers to use as a courtesy or paid Service. This may decrease transaction costs of transmitting NFTs between different distributed ledgers.

In an embodiment, the payee's wallet and payor's wallet may be located on different distributed ledgers. The program may automatically create an NFT that may be transmitted between the two ledgers, with the appropriate protocols and metadata.

In an embodiment, the distributed ledger may be a blockchain. A blockchain may be more secure and permanent than other types of distributed ledgers.

In an embodiment, the one or more payment terms or payment may be accessed through a hyperlink within the NFT. For example, the NFT may simply contain a link (hyperlink or otherwise) to the data or a representation of the data (such as a. pdf), instead of, or in addition to including the data within the NFT itself. Hyperlinks may become stale and inaccessible over time.

In an embodiment, the NFT, and/or the data included within the NFT, may be machine-readable. Machine-readable data may be encrypted. Machine-readable data may be in the form of a QR code, barcode, steganography, or other machine-readable format that may be inaccessible or illegible to human eyes.

In an embodiment, the e-cash payment computer program and/or the NET may transmit a report to the payor when certain conditions are met. These conditions may include, singularly or in any combination, inter alia: 1) the NFT being viewed (by the payor, the payee, or others) ; 2) the payment being conveyed to the payee; 3) the failure of the payee to select an option to convey the e-cash within a pre-determined amount of time; 4) the transfer of the NET from the payee to a third party; 5) the utilization of the NET as collateral or otherwise; 6) when the payment terms are viewed; 7) where the statement is stored (which distributed ledger and where on the ledger); 8) any other information useful to the payor or payee.

In an embodiment, the program may utilize one or more artificial intelligence/machine learning (“AI/ML”) algorithms to determine the contents of a report and when to send the report to the payor or payee. For example, if a payor has sent paychecks to 100 employees through an NFT, the program may use AI/ML algorithms to determine that the payor would utilize a report as to when each employee received the NFT and selected an option to convey the e-cash included with the NFT, along with what option was selected.

In an embodiment, the metadata within the NFT may include a record of where the NET has been located on the distributed ledger. This metadata may be updated as the NFT moves from address to address on the ledger. This metadata may be encrypted.

A method for utilizing a non-fungible token (“NFT”) for e-cash payment is provided. The method may include the step of assigning, to each of two or more users, a wallet on a distributed ledger. Each user may include a computer device. Each computer device may run an e-cash application. At least one of the two or more users may be a payee and at least one of the two or more users may be a payor.

The method may include the step of establishing, over a computer network, a connection between each computer device.

The method may include the step of receiving, via the connection and from one of the two or more users, one or more payment terms.

The method may include the step of initiating a payment from the payor according to the one or more payment terms. The one or more payment terms may include an identity of the payor, an identity of the payee, an amount of the payment, e-cash, and one or more options to convey the e-cash selectable by the payee. The e-cash may include a digital representation of a portion of funds available to the payor.

The method may include the step of minting a non-fungible token (“NET”) within the wallet assigned to the payor. The NFT may include metadata, the payment, other data, and one or more smart contracts. The NFT may be singular.

The one or more smart contracts may include code created by a request intent extractor, an intelligent feature processor, and a multi-module real-time intelligent feature bundler.

The request intent extractor may be configured to determine an intent for the one or more smart contracts.

The intelligent feature processor may be configured to determine which one or more features located within a central feature catalog corresponds with the intent and are compatible with the distributed ledger.

The intelligent feature processor may be configured to transmit the determined one or more features to the multi-module real-time intelligent feature bundler.

The multi-module real-time intelligent feature bundler may be configured to receive the one or more determined features, extract source code corresponding to the one or more determined features from a store of source code and bundle the extracted source code to create the one or more smart contracts.

The method may include the step of transmitting, via the connection, an option to the payee to accept or reject a transfer of the NFT

When the payee accepts the transfer of the NFT, the method may include the step of transferring, via the connection and after receiving an authorization from the payor, the NFT to the wallet assigned to the payee.

The method may include the step of confirming receipt of the NFT at the payee distributed ledger wallet.

The method may include the step of conveying the e-cash as instructed by the payee.

An apparatus for e-cash payment utilizing distributed ledger technology is provided. The apparatus may include one or more computers running a distributed ledger, a database, a payor computer device, and a payee computer device.

The database may include a central feature catalog and a store of source code.

The payor computer device may include a payor communication link, a payor processor, and a payor non-transitory memory. The non-transitory memory may be configured to store at least an operating system and a copy of an e-cash payment computer program.

The payee computer device may include a payee communication link, a payee processor, and a payee non-transitory memory. The non-transitory memory may be configured to store at least an operating system and a copy of an e-cash payment computer program.

The e-cash may include a digital representation of a portion of funds available to the payor.

A wallet on the distributed ledger may be assigned to the payor.

A wallet on the distributed ledger may be assigned to the payee.

A connection, over a computer network, may be established between the payor computer device and the payee computer device.

The payee computer device may transmit, via the connection, one or more payment terms comprising: an identity of the payor, an identity of the payee, an amount of the payment, a location of one or more assets comprising the payment, and one or more options to convey the e-cash selectable by the payee.

The payor computer device may receive, via the connection, the one or more payment terms.

The payor computer device may initiate a payment according to the one or more payment terms.

The e-cash payment program may mint a singular non-fungible token (“NFT”) comprising metadata and one or more smart contracts within the wallet assigned to the payor.

The program may transmit, via the connection, an option to the payee to accept or reject a transfer of the NFT.

When the payee accepts the transfer of the NFT, the program may transfer, via the connection and after receiving an authorization from the payor, the NFT to the wallet assigned to the payee.

The program may confirm receipt of the NET at the payee distributed ledger wallet and convey the e-cash as instructed by the payee.

The one or more smart contracts may include code created by a request intent extractor, an intelligent feature processor, and a multi-module real-time intelligent feature bundler.

The request intent extractor may be configured to determine an intent for the one or more smart contracts.

The intelligent feature processor may be configured to determine which one or more features located within a central feature catalog corresponds with the intent and are compatible with the distributed ledger.

The intelligent feature processor may be configured to transmit the determined one or more features to the multi-module real-time intelligent feature bundler.

The multi-module real-time intelligent feature bundler may be configured to receive the one or more determined features, extract source code corresponding to the one or more determined features from a store of source code, and bundle the extracted source code to create the one or more smart contracts.

In an embodiment, the metadata within the NFT may include a record of where the NFT has been located on the distributed ledger.

In an embodiment, the pre-determined length of time may be 180 days after receipt of the NFT at the payee's distributed ledger wallet.

In an embodiment, the computer program may utilize artificial intelligence/machine learning (“AI/ML”) to perform any of its functions, including the creation of the NFT and creation of the one or more smart contracts. For example, the program may analyze the payment terms and the distributed ledger(s) and determine that the one or more smart contracts should be in a particular form to be effective on the payee's distributed ledger. Or the program may analyze the past history between the payor and payee and determine that previous iterations were accurate and copy one or more aspects of previous iterations.

The e-cash payment computer program may confirm receipt of the NFT at the payee distributed ledger wallet and record the confirmation on the distributed ledger.

In an embodiment, the distributed ledger may be a blockchain.

The program may transfer the NFT through the use of a private cryptographic key to the payee's wallet or any other secure and appropriate method. The program may transfer the NFT to the payee's wallet via a (public) cryptographic key while keeping a private version of the cryptographic key hidden and available only to the payor.

The one or more smart contracts may be computer programs adapted to perform various functions, such as displaying the options for transferring the e-cash or the NFT, holding the NFT (with its embedded payment) in trust for the payee, and other functions.

The program may transfer the NET to the payee's distributed ledger wallet (or other address on the distributed ledger) through the use of a private cryptographic key to the payee's wallet, or any other appropriate method.

The program may transfer the NET to the payee's distributed ledger wallet (or other address on the distributed ledger) via a (public) cryptographic key while keeping a private version of the cryptographic key hidden and available only to the program. Transferring the NFT may be recorded on the ledger. If the ledger is a blockchain, the transfer may be data to form a new block on the blockchain. Only the user who has control of the wallet the NFT is in may transfer the NFT.

The wallet holding the NFT may be accessed through a private key and a public key or other appropriate cryptographic method. The private key/public key paradigm may be referred to as a digital signature. A private key/public key paradigm may consist of three or more algorithms: 1) a key generation algorithm that creates or selects a private key and a corresponding public key; 2) a signing algorithm that produces a ‘signature’ when provided a message and a private key; and 3) a signature verifying algorithm can verify a signature's authenticity when given the message, the public key and signature. The keys generated are not generally reproducible (or guessed) by non-computers and may be stored in various file formats on a computer. The keys may be more secure than standard passwords. The keys may be secured encrypted with any appropriate encryption algorithm.

In general, the authenticity of a signature generated from a message and private key can be verified by using the corresponding public key. In addition, in order for a private key to be secure, it should be computationally infeasible to generate a valid signature for a party without knowing that party's private key. A password as a private key may be less secure when compared to an extensive code (i.e., a key) that may be located on a file on a computer or storage device.

As the ledger is secure and history cannot be altered, a transfer of the NET to a different address will be apparent in the ledger. For example, an NET may be assigned to one address and appear in the payee's wallet. As the NFT is non-fungible, no other copy of the NET will have appeared on the ledger before transfer to the payee other than the payor, and any copy after assignment may be immediately visible on the ledger. The NFT'S location, e.g., in the payee's wallet, is known and appears on the ledger. Any transfer to a different address will appear on the ledger, otherwise the transfer will have been ineffective. In addition, any licit or illicit copies of the NFT will be readily ascertainable by view of the ledger and tracing the NFT back to its original wallet.

In an embodiment, the e-cash program may be implemented within an existing software application (such as an existing banking application, or a web browser). The application may be on a mobile computing device or a personal computing device. In another embodiment, the e-cash program may be k implemented within a stand-alone software application on a mobile computing device or a personal computing device.

In an embodiment, the executable instructions may include firmware embedded in hardware, as opposed to software.

A processor(s) may control the operation of the apparatus and its components, which may include RAM, ROM, an input/output module, and other memory. The microprocessor may also execute all software running on the apparatus. Other components commonly used for computers, such as EEPROM or Flash memory or any other suitable components, may also be part of the apparatus.

A communication link may enable communication with any computing device where the payor or payee may attempt to create and transfer the NFT as well as any server or Servers. The communication link may include any necessary hardware (e.g., antennae) and software to control the link. Any appropriate communication link may be used. In an embodiment, the network used may be the Internet. In another embodiment, the network may be an internal intranet.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMS, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

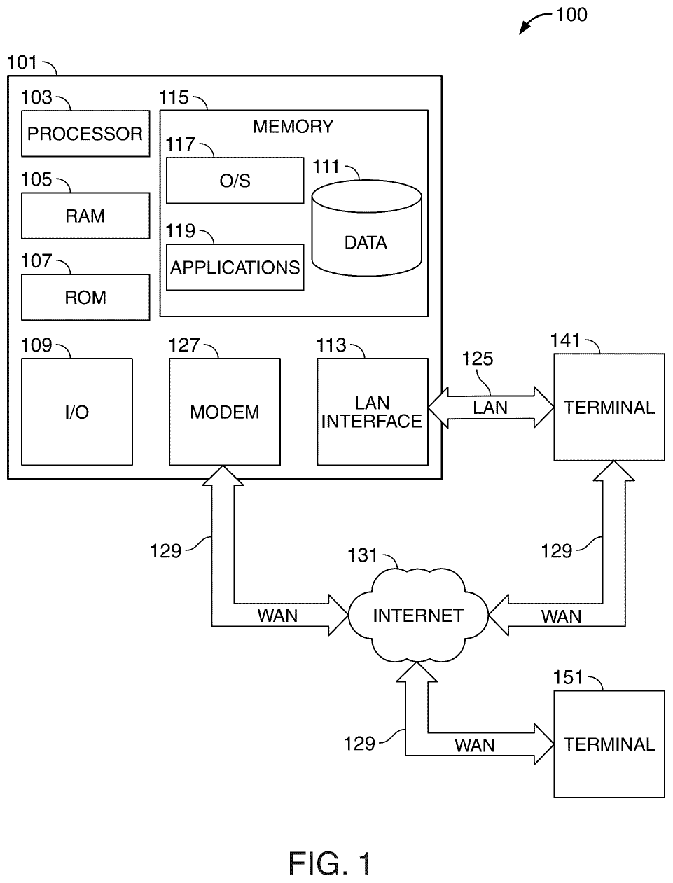

In accordance with principles of the disclosure, FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or a human, such as a payor or payee.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as a distributed ledger, user wallets/addresses, e-cash payment program, and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as a distributed ledger, user wallets/addresses, e-cash payment program) along with any other data 111 (NFT data, ledger data) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology-e.g., a hard drive or other non-transitory memory. The memory may store software including an operating system and any application(s) (such as a distributed ledger, user wallets/addresses, e-cash payment program) along with any data needed for the operation of the apparatus and to allow authentication of a user. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, or servers that include many or all the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, Computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for distributed ledgers, user wallets/addresses, and e-cash payment program(s). In an embodiment, the e-cash payment program may use one or more AI/ML algorithm(s). The various tasks may be related to using a distributed ledger and an NFT to remit a payment and statement together.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where the user is interacting with an application for e-cash payments.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other Computers, and/or other personal digital assistants (“PDAS”), multiprocessor systems, microprocessor-based systems, set top boxes, programmable consumer electronics, network PCS, minicomputers, mainframe computers, distributed computing environments that include any of the above systems or devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g. cloud-based applications. In a distributed computing environment, program modules maybe located in both local and remote computer storage media including memory storage devices.

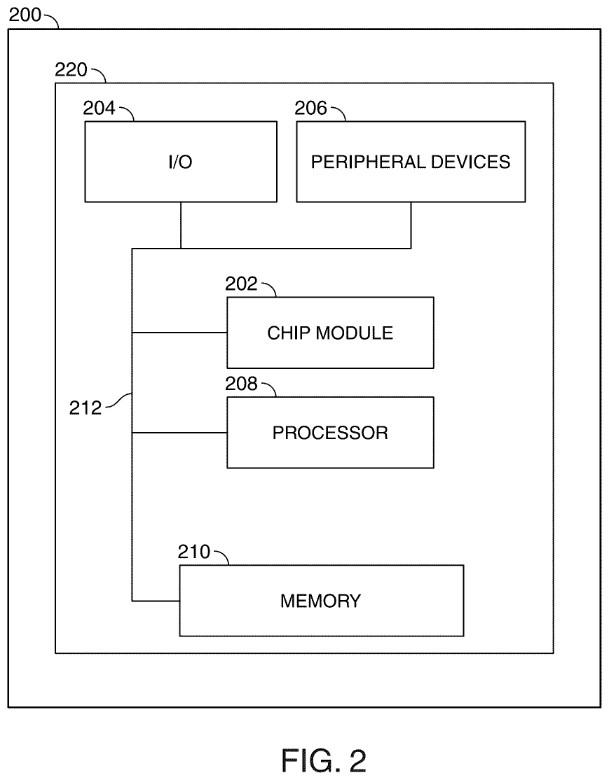

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-8. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.) , a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

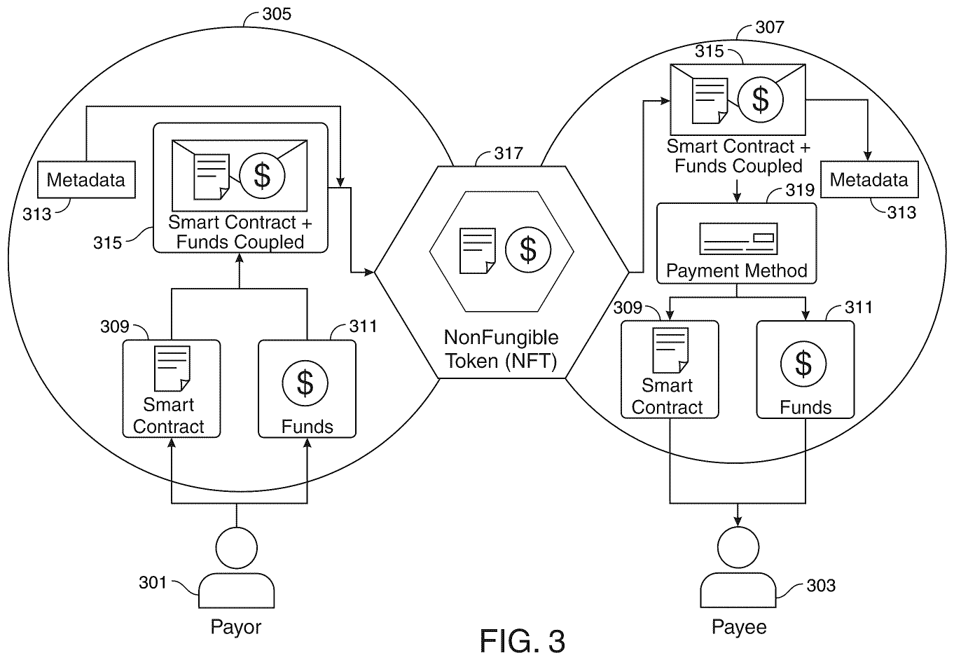

FIG. 3 shows an illustrative schematic apparatus in accordance with principles of the disclosure. A payor 301 may have access to a payor digital wallet 305. The payor wallet 305 may be an address on a distributed ledger (not shown). A payee 303 may have access to a payee digital wallet 307. The payee wallet 307 may be on the same or a different distributed ledger as the payor wallet 305.

The payor 301 may authorize a computer program (not shown) to create an NFT 317. The payor 301 may provide one or more payment terms. Payor 301 may provide funds 311. The program may create one or more smart contracts 309 to include with the NFT 317.

The program may couple the smart contract 309 and funds 311 together to create a digital envelope 315. Digital envelope 315 may be an initial version of an NFT, or a partial version 41 an NFT. The program may create an NFT 317 by combining the digital envelope 315 with metadata 313, along with any other suitable or necessary data (not shown).

When authorized by the payor 301, the NFT 317 may be transferred from the payor wallet 305 to the payee wallet 307. Once the NET 317 is at the payee wallet 307, the payee 303 may select a payment method 319 and receive the funds 311 and the smart contract 309. In an embodiment, the smart contract 309 may include the program wherein the payee may choose how to receive the funds 311.

In an embodiment, the payee 303 may hold onto the NFT 317 without selecting an option for a length of time. In an embodiment, the payee 303 may transfer the NFT 317 to a third party's wallet without selecting a payment option 319 and the third party may select a payment option 319.

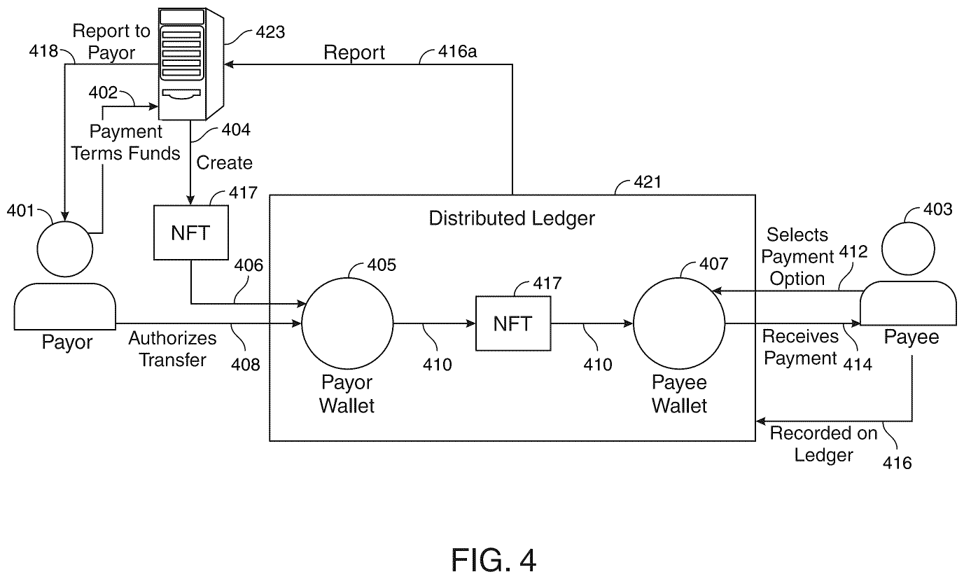

FIG. 4 shows an illustrative schematic in accordance with principles of the disclosure. Methods may include some or all of the method steps even-numbered 402-418 on apparatus odd-numbered 405-423, by payor 401 and payee 403. Methods may include the steps illustrated in FIG. 4 in an order different from the illustrated order. The illustrative method shown in FIG. 4 may include one or more steps performed in other figures or described herein. Steps 402-418 may be performed on the apparatus shown in FIGS. 1-8, or other apparatus.

A payor 401 may transmit one or more payment terms and payment funds to program located at a computer 423 at step 402. The program may create an NFT 417 at step 404 and transfer the NFT to a payor wallet 405 at step 406. The payor wallet 405 and payee wallet 407 may be addresses on distributed ledger 421.

Payor 401 may authorize the transfer of NFT 417 from payor wallet 405 to payee wallet 407 at step 408. The NFT 417 may be transferred at step 410. Payee 403 may select a payment option to receive the payment funds at step 412 and may receive the payment funds at step 414. The receipt of the funds and the selected payment option may be recorded on distributed ledger 421 at step 416. This recordation on the ledger may be read by the program and computer 423 after it occurs at step 418. At step 420, the program may report to the payor 401 the status of the NFT 417 along with the status of the payment statement and payment funds.

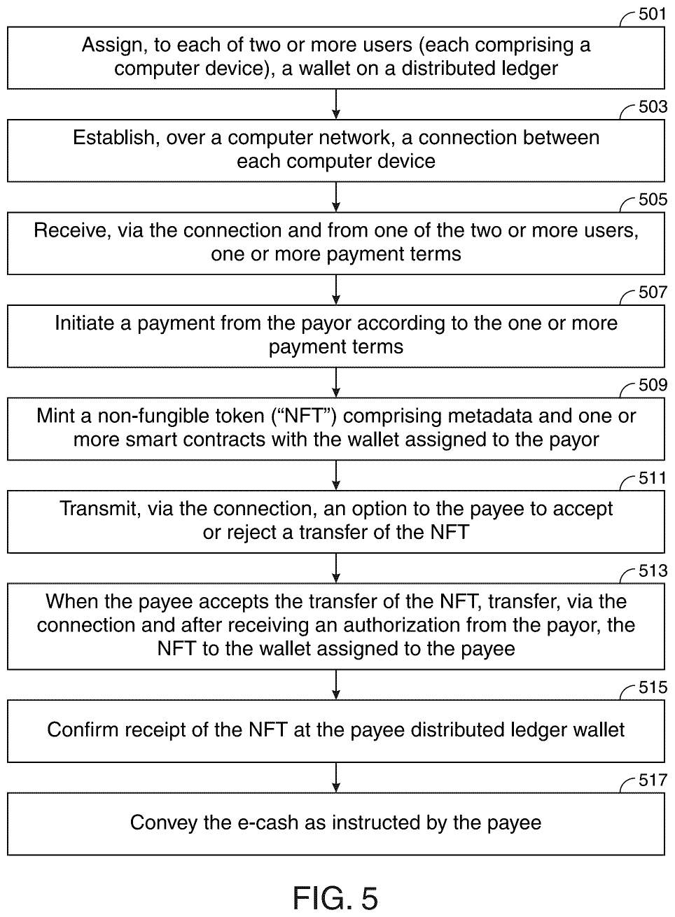

FIG. 5 shows an illustrative flowchart in accordance with principles of the disclosure. Methods may include some or all of the method steps numbered 501 through 517. Methods may include the steps illustrated in FIG. 5 in an order different from the illustrated order. The illustrative method shown in FIG. 5 may include one or more steps performed in other figures or described herein. Steps 501 through 517 may be performed on the apparatus shown in FIGS. 1-8, or other apparatus.

At step 501, assign by an e-cash payment computer program located at a computer device, to each of two or more users, a wallet on a distributed ledger. Each user may include a computer device.

At step 503, establish over a computer network, a connection between each computer device.

At step 505, the program may receive, via the connection and from one of the two or more users, one or more payment terms. The one or more payment terms may be, inter alia: an identity of the payor, an identity of the payee, an amount of the payment, a location of one or more assets comprising the payment, and one or more options to convey the e-cash selectable by the payee, among other terms.

At step 507, initiate a payment from the payor according to the one or more payment terms.

At step 509, the program may mint an NFT within a distributed ledger wallet belonging to the payor. The NET may include the payment, one or more smart contracts, as well as metadata and other data. The NET or its data may be encrypted. The confirmation may be accomplished by checking the distributed ledger and its records. The transfer may be recorded in the metadata, on the ledger, or in other locations.

At step 511, the program may transmit, via the connection, an option to the payee to accept or reject a transfer of the NFT.

When the payee accepts the transfer of the NFT, transfer, via the connection and after receiving an authorization from the payor, the NFT to the wallet assigned to the payee at step 513.

At step 515, the program may confirm receipt of the NFT at the payee distributed ledger wallet.

At step 517, the program may convey the e-cash as instructed by the payee after the payee selected one of the options.

The method may include reporting the status of the NFT and/or the payment funds to the payor. Other reports may be generated and transmitted to the payor as requested or as necessary. The reports may be generated at pre-determined intervals (e.g., every day, every week), variable intervals, and/or when a payment option is selected by the payee. The program may read and review the distributed ledger to discover information to include in the report(s), as any action or inaction by the payee with respect to the NFT may be recorded on the distributed ledger.

In an embodiment, the NFT or e-cash may be returned to the payor's wallet after a pre-determined amount of time when the payee does not select a payment option or does not use all of the e-cash. For example, a check may be valid for 180 days and if it is not cashed within that time, it is no longer valid, and the funds may be returned to the payor/remitter.

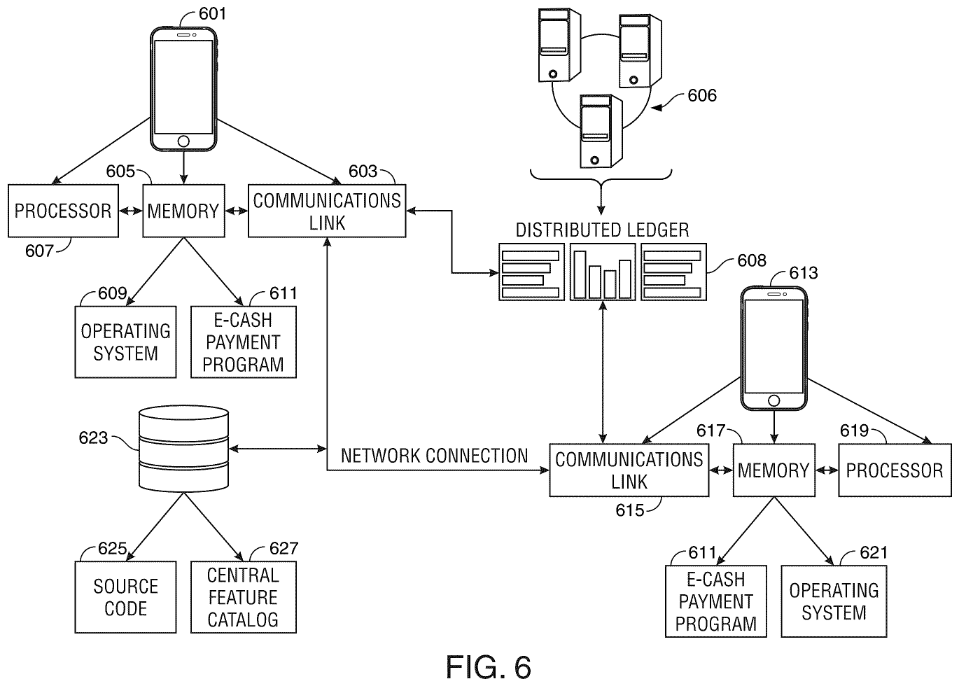

FIG. 6 shows an illustrative apparatus in accordance with principles of the disclosure.

One or more computers 606 may run/ support a distributed ledger/blockchain 608.

A database 623 may include, among other data, a central feature catalog 627 and a store of source.

A payor computer device 601 may include a communications link 603, a non-transitory memory 605, and a processor 607, among other components.

Non-transitory memory 605 may include an operating system 609 and an e-cash payment computer program 611, among other programs.

A payee computer device 613 may include a communications link 615, a non-transitory memory 617, and a processor 619, among other components.

Non-transitory memory 617 may include an operating system 621 and a copy of the e-cash payment computer program 611, among other programs.

Payor computer device 601 and payee computer device 613 may communicate with each other, communicate with the computers 606 running the distributed ledger 608, and communicate with the database 623 through communications links 603 and 615.

The e-cash computer program 611 may be used to transfer e-cash from the payor to the payee through the distributed ledger 608.

E-cash may include a digital representation of a portion of funds available to the payor.

A wallet on the distributed ledger 608 may be assigned to the payor. A wallet on the distributed ledger 608 may be assigned to the payee.

A connection, over a computer network, may be established between the payor computer device 601 and the payee computer device 613.

The payee computer device 613 may transmit, via the connection, one or more payment terms that may include: an identity of the payor, an identity of the payee, an amount of the payment, a location of one or more assets comprising the payment, and one or more options to convey the e-cash selectable by the payee. The payment terms may be set on the e-cash payment program 611.

The payor computer device 601 may receive, via the connection, the one or more payment terms. The payment terms may be received on the e-cash payment program 611.

The payor computer device 601 (i.e., a user using the device) may initiate a payment according to the one or more payment terms through the e-cash payment program 611.

The e-cash payment program 611 may mint a singular non-fungible token (“NFT”) comprising metadata and one or more smart contracts within the wallet assigned to the payor on the distributed ledger 608.

The e-cash payment program 611 may transmit, via the connection, an option to the payee to accept or reject a transfer of the NFT.

When the payee accepts the transfer of the NFT, the e-cash payment program 611 may transfer, via the connection and after receiving an authorization from the payor, the NFT to the wallet assigned to the payee on the distributed ledger 608.

The e-cash payment program 611 may confirm receipt of the NET at the payee distributed ledger wallet.

The e-cash payment program 611 may convey the e-cash as instructed by the payee.

The one or more smart contracts may include code created by the e-cash payment program 611. Specifically, the e-cash payment program 611 may include a request intent extractor configured to determine an intent for the one or more smart contracts.

The e-cash payment program 611 may include an intelligent feature processor configured to determine which one or more features located within a central feature catalog 627 corresponds with the intent and are compatible with the distributed ledger. The intelligent feature processor may transmit the determined one or more features to a multi-module real-time intelligent feature bundler of the e-cash payment program 611.

The multi-module real-time intelligent feature bundler may be configured to receive the one or more determined features, extract source code corresponding to the one or more determined features from a store of source code 625, and bundle the extracted source code to create the one or more smart contracts.

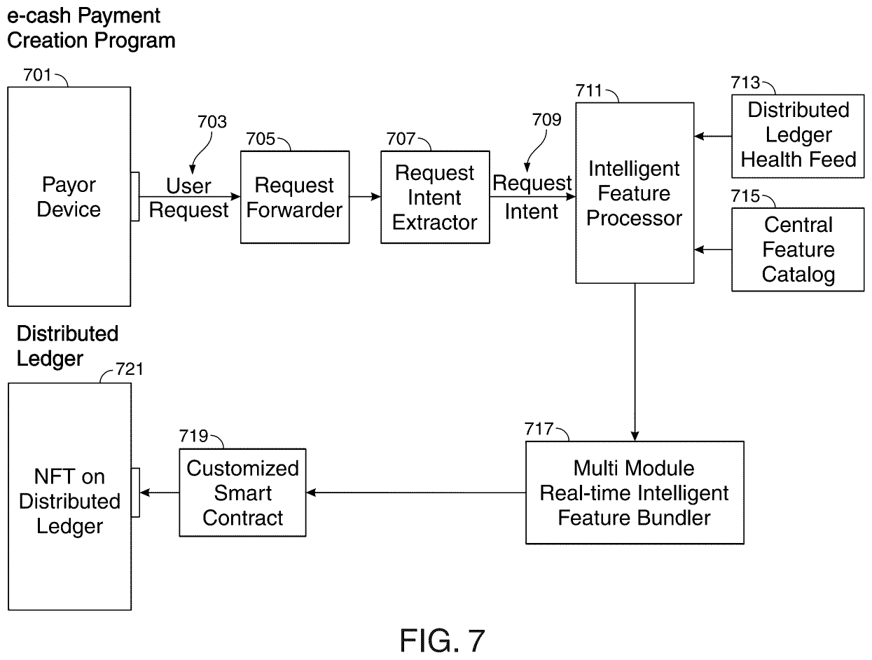

FIG. 7 shows an illustrative schematic in accordance with the principles of the disclosure. Apparatus and information numbered 701-721 may include some or all of the components in FIGS. 1-8.

An e-cash payment program may be located on a payor's computing device 701. The e-cash payment program may include a request forwarder 705, a request intent extractor 707, an intelligent feature processor 711, and a multi-module real-time intelligent feature bundler 717, among other modules.

A payor request 703 for an e-cash NFT may be transmitted from user device 701 to a request forwarder module 705. The request forwarder 705 may be a module of the payment program. Request forwarder 705 may forward the payor request 707 to a request intent extractor 707.

Request intent extractor 707 may analyze the payor request 707 and determine one or more intents 709 behind the request 707. For example, the extractor 707 may determine that a payor request 707 includes the intent to transfer money from one bank account to another.

The request intent(s) 709 may be transmitted to an intelligent feature processor 711. A distributed ledger health feed 717 and a central feature catalog 715 may be electronically coupled to the intelligent feature processor 711. Output channel health feed 713 and central feature catalog 715 may communicate and provide data to the intelligent feature processor 711. Central feature catalog 715 may be located on a database (not shown). The database may be a part of the same device on which intelligent feature processor 711 is located.

Intelligent feature processor 711 may communicate with the multi-module real-time intelligent feature bundler 717, which may be located on the same device. In an embodiment, intelligent feature processor 711 may transmit one or more features and the appropriate details for a payer's wallet on a distributed ledger for the customized smart contract/NFT 719. The feature bundler 717 may extract source code from a source code repository (not shown) and bundle the source code and package it within one or more smart contracts so that the smart contracts 719 may execute properly on a target distributed ledger/NFT 721. The target distributed ledger/NFT 721 may be the distributed ledger on which the payee's wallet is located.

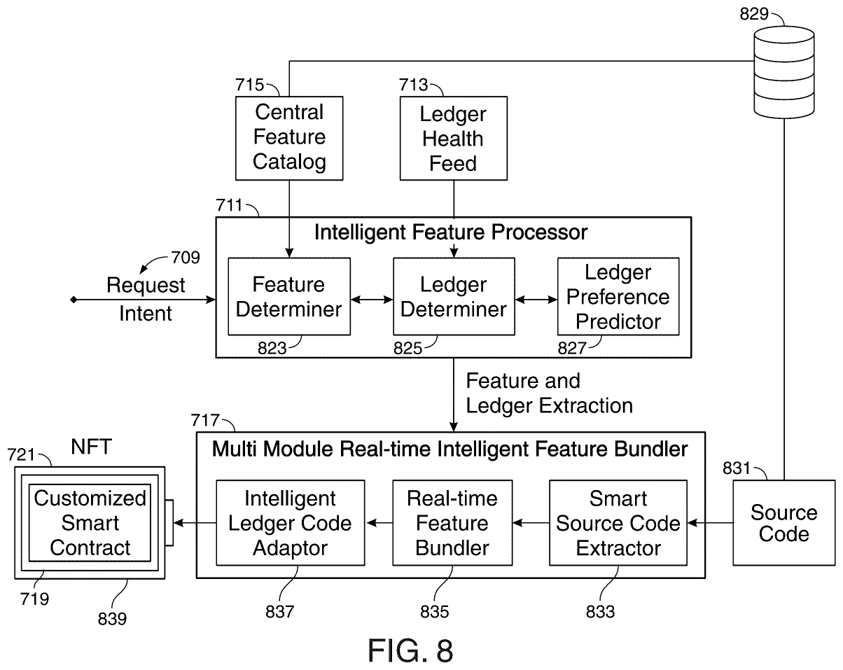

FIG. 8 shows an illustrative schematic in accordance with the principles of the disclosure. Like numbered elements with FIG. 7 are the same elements as in FIG. 7.

Intelligent feature processor 711 may include a feature determiner module 823, a ledger determiner module 825 and a ledger preference predictor 827, among other modules (not shown). Feature processor 711 may be configured to determine which features correspond with the user's request intent 709 using the feature determiner 823.

Intelligent feature processor 711 may also determine which target output ledger would be the most appropriate for the features identified that would satisfy the request intent 709. Feature processor 711 may make this determination utilizing ledger determiner 825 and ledger preference predictor 827.

Central feature catalog 715 and source code repository 831 may be located in non-transitory memory in database 829.

Intelligent feature processor 711 may transmit one or more features and a target output ledger identification to the multi-module real-time intelligent feature bundler 717. Feature bundler 717 may include a smart source code extractor 833, a real-time feature bundler 835, and an intelligent ledger code adaptor 837. Feature bundler may form the customized smart contract(s) 719 by extracting source code corresponding to the identified features and identified target output ledger 721 from the source code repository 831, bundling/compiling the source code, and adapting the bundled/compiled source code to the NFT 721.

The customized smart contract(s) 719 may be transmitted to the identified target output ledger/NFT 721 by the multi-module real-time intelligent feature bundler 717. The target output ledger/NFT 721 may include a plug-in code container 839. The customized smart contract(s) 719 may be executed within the NFT 839.

Thus, apparatus and methods for utilizing NFTs for e-cash payments are provided. Persons skilled in the art will appreciate that the present invention can be practiced by other than the described embodiments, which are presented for purposes of illustration rather than of limitation.

1. An e-cash payment computer program product, the computer program product comprising executable instructions stored on non-transitory memory of a computer system, the executable instructions when executed by a processor on the computer system:
assign, to each of two or more users, a separate wallet on a distributed ledger, wherein:
each user comprises a computer device running the computer program product; and
at least one of the two or more users is a payee and at least one of the two or more users is a payor;
establish, over a computer network, a connection between each computer device;
receive, via the connection and from one of the two or more users, one or more payment terms;
initiate a payment from the payor according to the one or more payment terms;
mint a non-fungible token (“NFT”) comprising metadata and one or more smart contracts within the wallet assigned to the payor;
transmit, via the connection, an option to the payee to accept or reject a transfer of the NFT;
when the payee accepts the transfer of the NFT, transfer, via the connection and after receiving an authorization from the payor, the NFT to the wallet assigned to the payee;
confirm receipt of the NFT at the payee distributed ledger wallet; and
convey the e-cash as instructed by the payee;
wherein:
the e-cash comprises a digital representation of a portion of funds available to the payor;
the NFT is singular;
the one or more payment terms comprise:
an identity of the payor;
an identity of the payee;
an amount of the payment;
the e-cash; and
one or more options to convey the e-cash selectable by the payee; and
the one or more smart contracts comprise code created by:
a request intent extractor configured to determine an intent for the one or more smart contracts;
an intelligent feature processor configured to:
determine which one or more features located within a central feature catalog corresponds with the intent and are compatible with the distributed ledger; and
transmit the determined one or more features to a multi-module real-time intelligent feature bundler; and
the multi-module real-time intelligent feature bundler is configured to:
receive the one or more determined features;
extract source code corresponding to the one or more determined features from a store of source code; and
bundle the extracted source code to create the one or more smart contracts.

2. The e-cash payment computer program of claim 1 wherein one or more of the one or more payment terms are encrypted.

3. The e-cash payment computer program of claim 1 wherein the NFT is encrypted.

4. The e-cash payment computer program of claim 1 wherein the payee distributed ledger wallet and the payor distributed ledger wallet are located on one distributed ledger.

5. The e-cash payment computer program of claim 1 wherein the one or more payment terms are accessed through a hyperlink.

6. The e-cash payment computer program of claim 1 wherein the NFT is machine-readable.

7. The e-cash payment computer program of claim 1 wherein the program transmits a report to the payor when one or more of the following occurs:
1) the NFT is viewed; and
2) the payment is conveyed.

8. The e-cash payment computer program of claim 1 wherein one or more of:
the request intent extractor;
the intelligent feature processor; and
the multi-module real-time intelligent feature bundler
utilize one or more artificial intelligence/machine learning (“AI/ML”) algorithms.

9. The e-cash payment computer program of claim 8 wherein the one or more AI/ML algorithms analyze the one or more payment terms, historical data of the payor, historical data of the payee, and metadata.

10. The e-cash payment computer program of claim 1 wherein the NFT expires after a pre-determined amount of time.

11. The e-cash payment computer program of claim 10 wherein the pre-determined amount of time is set by the payor.

12. The e-cash payment computer program of claim 10 wherein the pre-determined amount of time is determined automatically through one or more AI/ML algorithms.

13. The e-cash payment computer program of claim 10 wherein when the NFT expires, all e-cash unused by the payee is returned to the payor.

14. The e-cash payment computer program of claim 1 wherein the computer network is wi-fi based.

15. The e-cash payment computer program of claim 1 wherein the computer network is li-fi based.

16. The e-cash payment computer program of claim 1 wherein one of the one or more options to convey the e-cash selectable by the payee comprises an option to convert from one currency to another currency.

17. The e-cash payment computer program of claim 1 wherein the e-cash is automatically converted from one currency to another currency.

18. The e-cash payment computer program of claim 1 wherein when the payee fails to select one of the one or more options within a predetermined amount of time, the NFT is automatically returned to the wallet assigned to the payor.

19. A method for utilizing a non-fungible token (“NFT”) for e-cash payment, the method comprising:
assigning, to each of two or more users, a separate wallet on a distributed ledger, wherein:
each user comprises a computer device; and
at least one of the two or more users is a payee and at least one of the two or more users is a payor;
establishing, over a computer network, a connection between each computer device;
receiving, via the connection and from one of the two or more users, one or more payment terms;
initiating a payment from the payor according to the one or more payment terms;
minting a non-fungible token (“NFT”) comprising metadata and one or more smart contracts within the wallet assigned to the payor;
transmitting, via the connection, an option to the payee to accept or reject a transfer of the NFT;
when the payee accepts the transfer of the NFT, transferring, via the connection and after receiving an authorization from the payor, the NFT to the wallet assigned to the payee;
confirming receipt of the NFT at the payee distributed ledger wallet; and
conveying the e-cash as instructed by the payee;
wherein:
the e-cash comprises a digital representation of a portion of funds available to the payor;
the NFT is singular;
the one or more payment terms comprise:
an identity of the payor;
an identity of the payee;
an amount of the payment;
the e-cash; and
one or more options to convey the e-cash selectable by the payee; and
the one or more smart contracts comprise code created by:
a request intent extractor configured to determine an intent for the one or more smart contracts;
an intelligent feature processor configured to:
determine which one or more features located within a central feature catalog corresponds with the intent and are compatible with the distributed ledger; and
transmit the determined one or more features to a multi-module real-time intelligent feature bundler; and
the multi-module real-time intelligent feature bundler is configured to:
receive the one or more determined features;
extract source code corresponding to the one or more determined features from a store of source code; and
bundle the extracted source code to create the one or more smart contracts.

20. An apparatus for e-cash payment utilizing distributed ledger technology, the apparatus comprising:
one or more computers running a distributed ledger;
a database comprising:
a central feature catalog; and
a store of source code;
a payor computer device comprising:
a payor communication link;
a payor processor;
a payor non-transitory memory configured to store at least:
an operating system; and
an e-cash payment computer program; and
a payee computer device comprising:
a payee communication link;
a payee processor;
a payee non-transitory memory configured to store at least:
an operating system; and
the e-cash payment computer program;
wherein:
the e-cash comprises a digital representation of a portion of funds available to the payor;
a wallet on the distributed ledger is assigned to the payor;
a wallet on the distributed ledger is assigned to the payee;
a connection, over a computer network, is established between the payor computer device and the payee computer device;
the payee computer device transmits, via the connection, one or more payment terms comprising: an identity of the payor, an identity of the payee, an amount of the payment, a location of one or more assets comprising the payment, and one or more options to convey the e-cash selectable by the payee;
the payor computer device receives, via the connection, the one or more payment terms;
the payor computer device initiates a payment according to the one or more payment terms;
the e-cash payment program:
mints a singular non-fungible token (“NFT”) comprising metadata and one or more smart contracts within the wallet assigned to the payor;
transmits, via the connection, an option to the payee to accept or reject a transfer of the NFT;
when the payee accepts the transfer of the NFT, transfers, via the connection and after receiving an authorization from the payor, the NFT to the wallet assigned to the payee;
confirms receipt of the NFT at the payee distributed ledger wallet; and
conveys the e-cash as instructed by the payee; and
the one or more smart contracts comprise code created by:
a request intent extractor configured to determine an intent for the one or more smart contracts;
an intelligent feature processor configured to:
determine which one or more features located within a central feature catalog corresponds with the intent and are compatible with the distributed ledger; and
transmit the determined one or more features to a multi-module real-time intelligent feature bundler; and
the multi-module real-time intelligent feature bundler is configured to:
receive the one or more determined features;
extract source code corresponding to the one or more determined features from a store of source code; and
bundle the extracted source code to create the one or more smart contracts.
